(19) United States
(12) Patent Application Publication
(10) Pub. No.: US 2012/0299691 A1
(43) Pub. Date: Nov. 29, 2012

(54) OVERCURRENT BREAKING ELEMENT-EQUIPPED TERMINAL

(75) Inventors: Shinichi Takase, Yokkaichi-shi (JP); Hiroki Hirai, Yokkaichi-shi (JP); Ryoya Okamoto, Yokkaichi-shi (JP); Masakuni Kasugai, Yokkaichi-shi (JP); Yuko Kinoshita, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/574,936

(22) PCT Filed: Feb. 1, 2011
(86) PCT No.: PCT/JP2011/051975

§ 371 Date: Jul. 24, 2012

(30) Foreign Application Priority Data
Feb. 3, 2010 (JP) 2010-022242
Jun. 7, 2010 (JP) 2010-129990

(51) Int. Cl. H01H 85/00

(52) U.S. Cl. 337/142

(57) ABSTRACT

An overcurrent breaking element-equipped terminal including a terminal main body having a terminal portion and a wire fixing portion and an overcurrent breaking element. The overcurrent breaking element includes a first lead wire connected to the terminal main body and a second lead wire connected to a terminal of a wire. The terminal main body includes an element connecting part that crimps and connects the first lead wire. The element connecting part is crimped on the first lead wire, and a double crimp terminal is crimped to connect the terminal of the wire to the second lead wire. Thus, the terminal main body, the overcurrent breaking element, and the wire are integrally provided.

### TECHNICAL FIELD

The present invention relates to an overcurrent breaking element-equipped terminal.

### BACKGROUND ART

In a current circuit from a power supply such as a battery to electric and electronic parts, a terminal equipped with an overcurrent breaking element to protect wires connecting the power supply to the electric and electronic parts from an overcurrent is sometimes used.

The overcurrent breaking element has a function to interrupt an electric current in which the overcurrent breaking element directly detects an overcurrent or indirectly detects heat generation caused by an overcurrent when an overcurrent is carried through wires electrically connecting the power supply to the electric and electronic parts.

For one equipped with an overcurrent breaking element like this, one described in Patent Document 1, for example, is known.

Patent Document 1 proposes a battery connection plate in a configuration in which a terminal connecting a battery to an overcurrent breaking element (an electronic component) is mounted on a plate main body using a terminal mounting cover.

### RELATED ART DOCUMENT

### Patent Document

Patent Document 1: Japanese Patent No. 3990960

### DISCLOSURE OF THE PRESENT INVENTION

### Problem to be Solved by the Invention

In the battery connection plate proposed in Patent Document 1 described above, since the overcurrent breaking element is connected to the terminal by soldering, there was a problem in that processing costs are high.

In the battery connection plate of Patent Document 1, it is necessary to provide a cover separate from a terminal and the plate main body as a member to mount the terminal for connecting a battery to an electronic component on the plate main body. Thus, there were problems in that the number of parts used is large and it takes time and effort to connect the terminal to the battery.

The present invention is completed based on the circumstances as described above. It is an object of the present invention to provide an overcurrent breaking element-equipped terminal that can reduce processing costs and the number of parts used.

### Means for Solving the Problem

In order to solve the problems above, the present invention provides an overcurrent breaking element-equipped terminal having a terminal main body including: a terminal portion connected to a power supply; and a wire fixing portion configured to crimp and fix a wire electrically connecting the power supply to a load; and an overcurrent breaking element configured to interrupt an electric current when an overcurrent is carried through the wire, or when a temperature of the wire reaches a set temperature or more. The overcurrent breaking element includes a first lead wire connected to the terminal main body and a second lead wire connected to a terminal of the wire. The terminal main body includes an element connecting part that crimps and connects the first lead wire. The element connecting part is crimped on the first lead wire, and a double crimp terminal is crimped to connect the terminal of the wire to the second lead wire for integrally providing the terminal main body, the overcurrent breaking element, and the wire.

In the present invention, the first lead wire of the overcurrent breaking element is connected to the terminal main body by crimping the element connecting part provided on the terminal main body, and the second lead wire of the overcurrent breaking element is connected to the terminal of the wire by crimping the double crimp terminal. In other words, according to the present invention, since soldering is unnecessary in connecting the overcurrent breaking element to the terminal main body and in connecting the terminal of the wire to the overcurrent breaking element, it is possible to reduce costs necessary for processing.

Moreover, in the present invention, the terminal main body includes the terminal portion, the wire fixing portion, and the element connecting part connected to the overcurrent breaking element. The members are crimped and connected to each other to integrally provide the terminal main body, the overcurrent breaking element, and the wire. In other words, according to the present invention, the terminal portion to be connected to the power supply, the wire fixing portion to fix the wire, and the element connecting portion to be connected to the overcurrent breaking element are provided on a single member (the terminal main body), and the members are crimped and connected to each other to form an integrated part. Thus, the number of parts is small, and it is possible to simplify the work of connecting to the power supply.

The present invention may include the following configuration.

The terminal main body may have a wall portion along a connecting portion region extending from a wire connecting portion where the terminal of the wire is connected to the second lead wire to an element connecting portion where the element connecting part is connected to the first lead wire.

With this configuration, it is possible to protect the wire connecting portion, the overcurrent breaking element, and the element connecting portion disposed in the connecting portion region extending from the wire connecting portion to the element connecting portion, and it is possible to enhance the rigidity of the terminal main body.

In the configuration above, the wall portion may have a reinforcing rib configured to reinforce the wall portion. With this configuration, it is possible to further enhance the rigidity of the terminal main body.

In the configuration above, the terminal portion may be formed so as to extend from the wall portion. This configuration is preferable because the wall portion is disposed between the terminal portion and the overcurrent breaking element and the wall portion functions as a dimension absorbing portion to absorb a shift between the positions of the power supply and the overcurrent breaking element.

The wire fixing portion may be a protection structure configured to prevent the damage on the wire crimped and fixed to the wire fixing portion.

When the end portion of the wire fixing portion crimping and fixing the wire damages the cladding of the wire caused as by biting into the wire in crimping, the end portion of the wire fixing portion sometimes penetrates through the cladding of the wire and contacts with a conductor and which can cause a short-circuit between the wire and the overcurrent breaking element. When the wire is short-circuited to the overcurrent breaking element, an electric current to be detected is not carried through the overcurrent breaking element, or the amount of an electric current to be detected, which is carried through the overcurrent breaking element, is reduced. Thus, the effect exerted by providing the overcurrent breaking element (the overcurrent breaking effect) cannot be sufficiently obtained.

Therefore, with the configuration above, it is possible to prevent the damage on the wire caused by the wire fixing portion, so that it is possible to prevent a short circuit between the overcurrent breaking element and the wire.

### Effect of the Invention

According to the present invention, it is possible to provide an overcurrent breaking element-equipped terminal that can reduce processing costs and the number of parts used.

### BRIEF DESCRIPTION OF THE DRAWINGS

FIG. 1 is a top view of an overcurrent breaking element-equipped terminal according to a first embodiment;

FIG. 2 is a perspective view of the overcurrent breaking element-equipped terminal before crimping a wire to a first lead wire;

FIG. 3 is a front view of the overcurrent breaking element-equipped terminal seen from the element connecting portion side;

FIG. 4 is a top view of a terminal main body before connecting the overcurrent breaking element thereto;

FIG. 5 is a perspective view of an overcurrent breaking element-equipped terminal accruing to a second embodiment before crimping a wire to a first lead wire;

FIG. 6 is a top view of an overcurrent breaking element-equipped terminal according to a third embodiment;

FIG. 7 is an enlarged diagram of the essential part depicted in FIG. 6;

FIG. 8 is a top view of a wire fixing portion of an overcurrent breaking element-equipped terminal described in one of other embodiment (2); and

FIG. 9 is a top view of a wire fixing portion in a different form from one in FIG. 8 described in one of other embodiment (2).

### EXPLANATION OF SYMBOLS

10: Overcurrent breaking element-equipped terminal
11: Terminal main body
12: Wire fixing portion
12A: Wire crimping part
13: Element connecting part
14D: Connecting portion region
15: Wall portion
16: Reinforcing rib
17: Terminal portion
20: Overcurrent breaking element
21: First lead wire
22: Second lead wire
23: Wire connecting portion
24: Element connecting portion
30: Wire
30A: Terminal
31: Stranded wires
32: Insulating cladding
40: Double crimp terminal
50: Protection structure
50A: Wire crimping part
50B: Protective tube

### BEST MODE FOR CARRYING OUT THE INVENTION

### First Embodiment

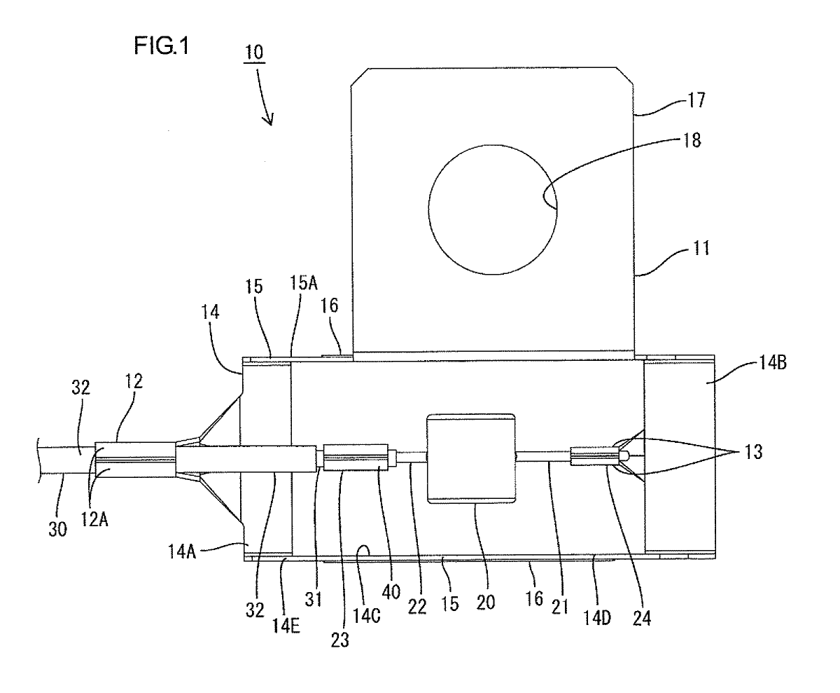

A first embodiment of the present invention will be described with reference to FIGS. 1 to 4. An overcurrent breaking element-equipped terminal 10 according to the present embodiment is used as a terminal 10 that connects the battery of an electric vehicle, a hybrid car, or the like (corresponding to a power supply, not shown) to an ECU (Electronic Control Unit, corresponding to a load, not shown), for example.

In the overcurrent breaking element-equipped terminal 10 according to the present embodiment (in the following, referred to as “the terminal 10”), as depicted in FIG. 1, a terminal main body 11, an overcurrent breaking element 20, and a wire 30 are integrally provided.

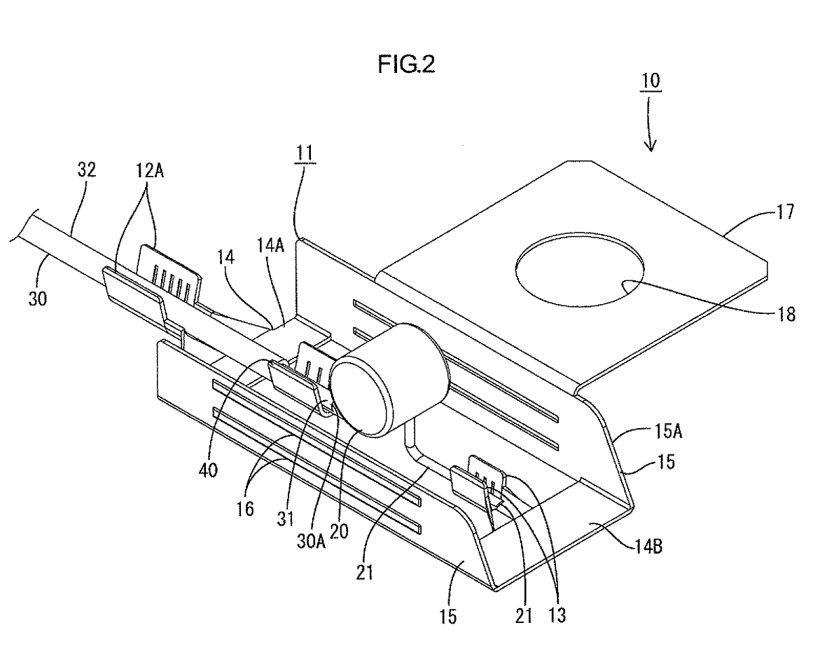

The wire 30 includes a large number of stranded wires 31 made of a conductive metal such as copper and an insulating cladding 32 that clads the stranded wires 31. Ata terminal 30A, the insulating cladding 32 is removed to expose the stranded wires 31 as depicted in FIG. 2. The terminal 30A of the wire 30 is connected to a second lead wire 22 of the overcurrent breaking element 20. A portion on the rear side of the terminal 30A of the wire 30 (in the upper left direction in FIG. 2) where the insulating cladding 32 clads the stranded wires 31 is fixed by crimping a pair of wires 30 crimping parts 12A and 12A. The portion where the wire 30 is fixed to the wire crimping parts 12A and 12A is a wire fixing portion 12 (see FIG. 1).

In the present embodiment, the wire 30 is used as a voltage detecting line, in which the overcurrent breaking element 20 interrupts an electric current when an overcurrent is carried through the wire 30, or when the temperature of the wire 30 reaches a set temperature or more.

For a specific example of the overcurrent breaking element 20, a PTC (Positive Temperature Coefficient) element or the like is named. A first lead wire 21 is attached to the end portion of the overcurrent breaking element 20 on the right side depicted in FIG. 1, and the second lead wire 22 is attached to the end portion on the left side in FIG. 1. The first lead wire 21 is connected by crimping element connecting parts 13 and 13 of the terminal main body 11, and the second lead wire 22 is connected to the terminal 30A of the wire 30 by crimping a double crimp terminal 40. The portion where the first lead wire 21 is connected to the element connecting parts 13 and 13 is an element connecting portion 24, and the portion where the terminal 30A of the wire 30 is connected to the second lead wire 22 is a wire connecting portion 23.

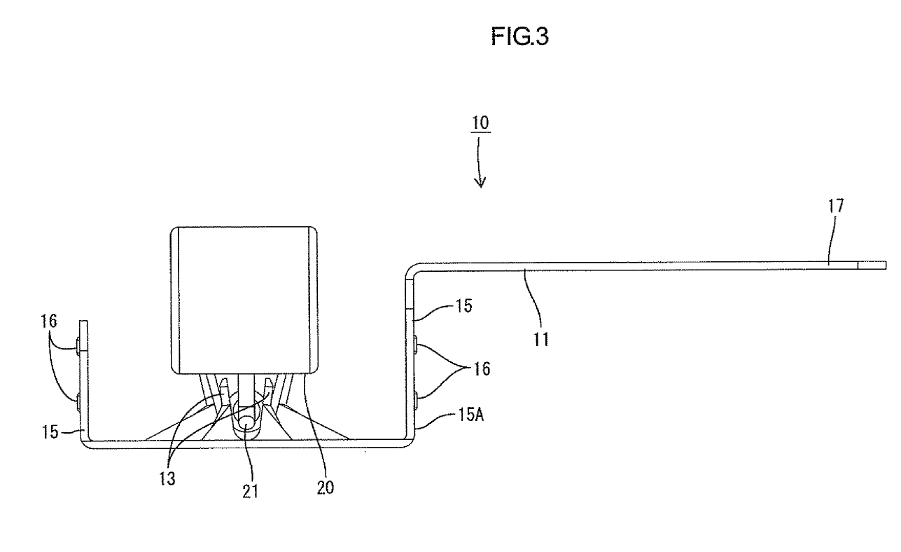

The terminal main body 11 has a box shape as a whole as depicted in FIG. 2. At a bottom part 14 of the terminal main body 11 (a portion provided on the lower side in FIG. 3), a pair of the wire crimping parts 12A and 12A that crimps and fixes the wire 30 and a pair of the element connecting parts 13 and 13 that crimps the first lead wire 21 of the overcurrent breaking element 20 are provided as depicted in FIG. 2. As depicted in FIG. 1, in the bottom part 14 of the terminal main body 11, an element region 14C is provided between a partial region 14A continuing from the wire fixing portion 12 (a region including the end portion on the left side in FIG. 1, which is referred to as a first region 14A) and a partial region 14B continuing from the element connecting portion 24 (a region including the end portion on the right side in FIG. 1, which is referred to as a second region 14B), and the element region 14C, in which the overcurrent breaking element 20 is disposed, is notched.

The terminal main body 11 has a pair of wall portions 15 and 15 erected almost vertical on the bottom part 14. In the present embodiment, as depicted in FIG. 1, the wall portions 15 and 15 include a connecting portion region 14D extending from the wire connecting portion 23 to the element connecting portion 24. The wall portions 15 and 15 are provided along a region 14E which is laterally wider than the connecting portion region 14D in FIG. 1. The region 14E is referred to as a wall portion defining region 14E. A pair of the wall portions 15 and 15 individually has two reinforcing ribs 16 in the longitudinal direction of the wall portions 15 and 15.

Moreover, the terminal main body 11 has a terminal portion 17 in which a portion extending in the crosswise direction from a wall portion 15A on the right side in FIG. 3 is bent as almost vertically to the wall portion 15A. The terminal portion 17 has a terminal insertion hole through which a power supply terminal provided on the power supply is inserted. In the following, the wall portion 15A on the right side in FIG. 3 is referred to as a terminal side wall portion 15A.

Next, a method of manufacturing the terminal 10 according to the present embodiment will be described.

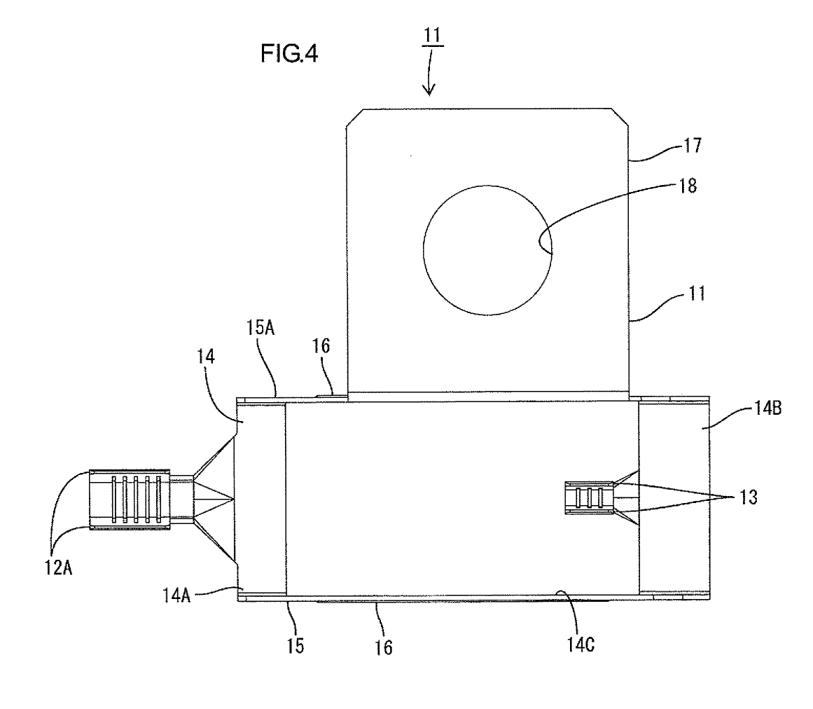

First, a metal plate is pressed and bent to prepare the terminal main body 11 in a shape depicted in FIG. 4. Subsequently, the element connecting parts 13 and 13 of the terminal main body 11 are crimped and connected to the first lead wire 21 of the overcurrent breaking element 20. Subsequently, the double crimp terminal 40 is double-crimped to connect the second lead wire 22 of the overcurrent breaking element 20 to the terminal 30A of the wire 30. Subsequently, the wire crimping parts 12A and 12A of the terminal main body 11 are crimped and fixed to the wire 30, and then the terminal 10 according to the present embodiment is obtained.

Next, the operation and effect of the present embodiment will be described.

In the present embodiment, the first lead wire 21 of the overcurrent breaking element 20 is connected to the terminal main body 11 by crimping the element connecting parts 13 and 13 provided on the terminal main body 11, and the second lead wire 22 of the overcurrent breaking element 20 is connected to the terminal 30A of the wire 30 by crimping the double crimp terminal 40. In other words, according to the present embodiment, soldering is unnecessary in connecting the overcurrent breaking element 20 to the terminal main body 11 and in connecting the terminal 30A of the wire 30 to the overcurrent breaking element 20, so that it is possible to reduce costs necessary for processing.

Moreover, in the present embodiment, the terminal main body 11 includes the terminal portion 17, the wire fixing portion 12, and the element connecting parts 13 and 13 connected to the overcurrent breaking element 20. The members are crimped and connected to each other to integrally provide the terminal main body 11, the overcurrent breaking element 20, and the wire 30. In other words, according to the present embodiment, the terminal portion 17 to be connected to the power supply, the wire fixing portion 12 to fix the wire 30, and the element connecting portion 24 to be connected to the overcurrent breaking element 20 are provided on the terminal main body 11, which is a single member, and the members are crimped and connected to each other to form an integrated part. Thus, the number of parts is small, and it is possible to simplify the work of connecting to the power supply.

Furthermore, according to the present embodiment, the wall portions 15 and 15 are provided along the wall portion defining region 14E including the connecting portion region 14D extending from the wire connecting portion 23 to the element connecting portion 24 of the terminal main body 11. Thus, it is possible to protect the wire connecting portion 23, the overcurrent breaking element 20, and the element connecting portion 24, which are disposed in the wall portion defining region 14E, and to enhance the rigidity of the terminal main body 11. Particularly in the present embodiment, since the reinforcing ribs 16 are provided on the wall portions 15 and 15, it is possible to further enhance the rigidity of the terminal main body 11.

In addition, according to the present embodiment, the terminal portion 17 is formed so as to extend from the terminal side wall portion 15A in the crosswise direction of the bottom part 14. Thus, the terminal side wall portion 15A is disposed between the terminal portion 17 and the overcurrent breaking element 20, and the terminal side wall portion 15A functions as a dimension absorbing portion to absorb a shift between the positions of the power supply and the overcurrent breaking element 20. Moreover, with this configuration, spaces are saved in the longitudinal direction of the bottom part 14.

### Second Embodiment

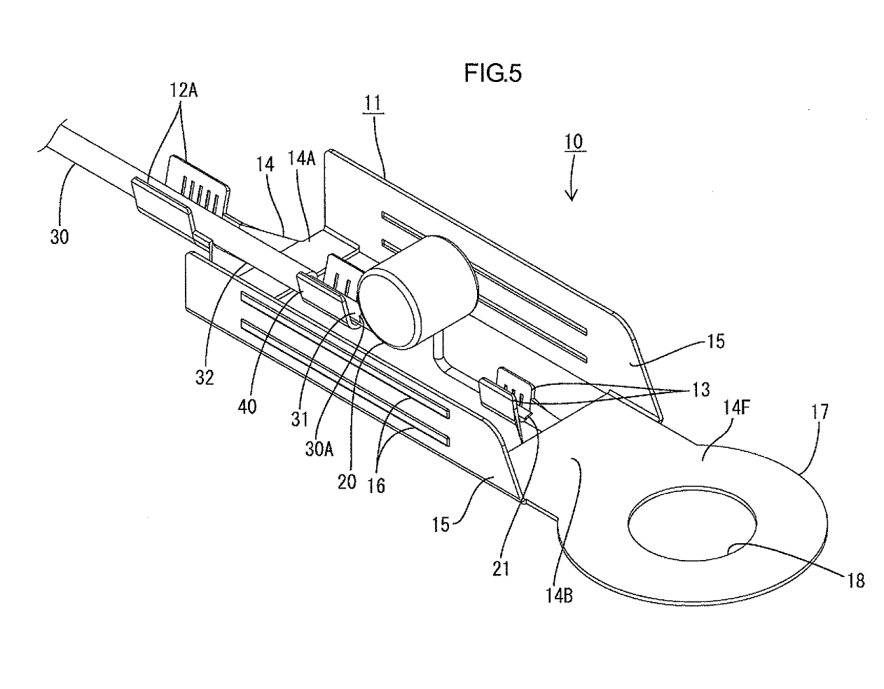

Next, a second embodiment of the present invention will be described with reference to FIG. 5. The present embodiment is different from the first embodiment in the position of the terminal portion 17. Component portions similarly configured as those in the first embodiment are designated the identical reference numerals for omitting the overlapping description.

In the present embodiment, a terminal portion 17 is provided in a third region 14F that is a bottom part 14 of a terminal main body 11 and extends in the longitudinal direction of the bottom part 14 from a second region 14B continuing from element connecting parts 13 and 13 (an element connecting portion 24).

According to the present embodiment, the terminal portion 17 is provided in the third region 14F extending from the bottom part 14 in the longitudinal direction, so that spaces are saved in the crosswise direction of the bottom part 14. The other configurations, operation, and effect are mostly the same in the first embodiment.

### Third Embodiment

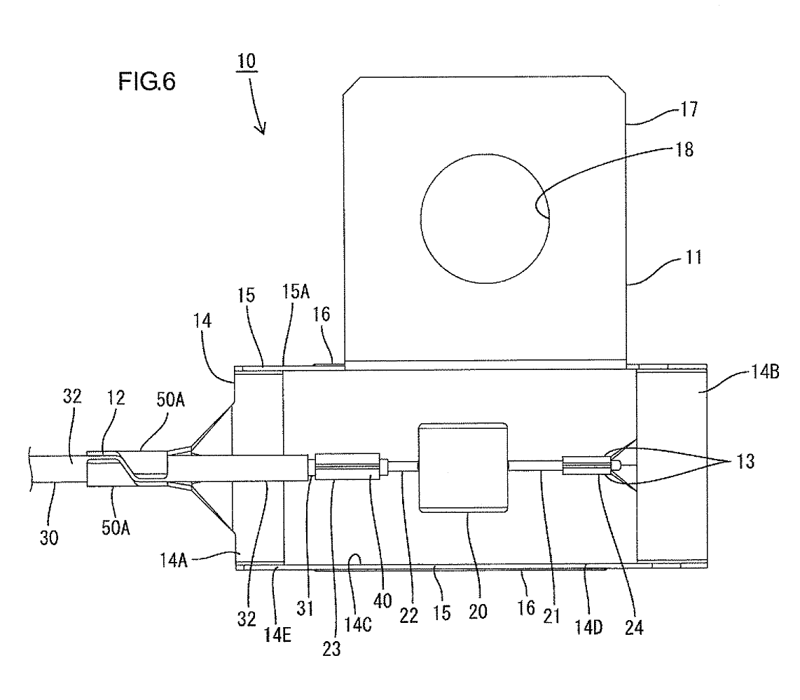

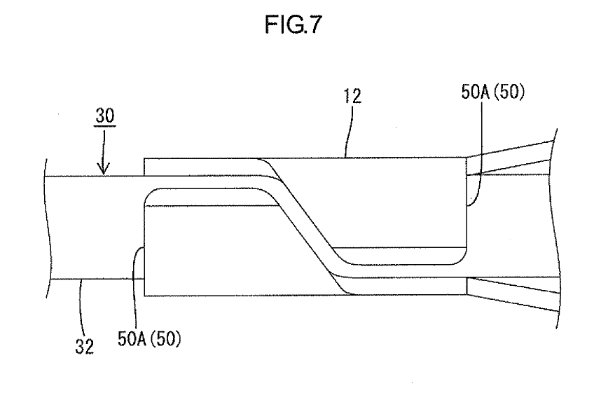

Next, a third embodiment of the present invention will be described with reference to FIGS. 6 and 7. A magneto-electric conversion element-equipped terminal 10 according to the present embodiment is different from the first embodiment in the structure of the wire fixing portion 12. Component portions similarly configured as the component portions in the first embodiment are designated the identical reference numerals for omitting the overlapping description.

In the present embodiment, as depicted in FIGS. 6 and 7, a wire fixing portion 12 includes a pair of trapezoid wire crimping parts 50A and 50A. These two wire crimping parts 50A and 50A are arranged so as not to overlap with each other, and the two wire crimping parts 50A and 50A are crimped on each other so as not to bite into an insulating cladding 32 of a wire 30. Thus, the damage on the wire 30 is prevented (corresponding to a protection structure 50 according to the present invention).

According to this embodiment, since the wire fixing portion 12 is the protection structure 50 that prevents the damage on the wire 30, it is possible to prevent a short circuit between the overcurrent breaking element 20 and the wire 30.

Other configurations, operation, and effect are mostly the same in the first embodiment.

### Other Embodiments

The present invention is not limited to the embodiments described with the description above and the drawings. For example, the following embodiments are also included in the technical scope of the present invention.

(1) In the aforementioned embodiments, the wall portion having the reinforcing ribs is shown. However, the wall portion without the reinforcing rib may be provided, or the wall portion may have one reinforcing rib or three or more reinforcing ribs.

(2) In the third embodiment, the protection structure 50 having the trapezoid wire crimping parts 50A and 50A is shown. However, the protection structure 50 that prevents the damage on the wire is not limited thereto.

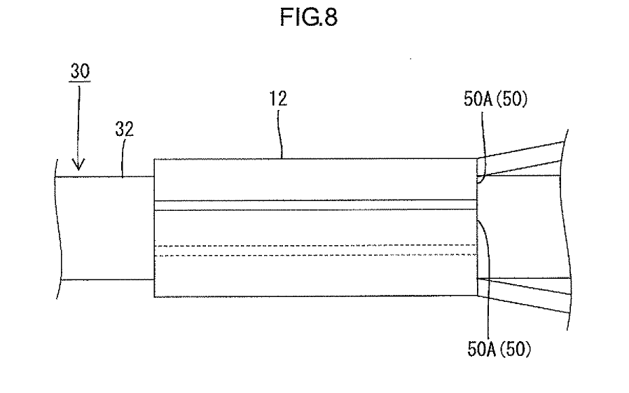

For example, as depicted in FIG. 8, a structure may be formed in which a pair of wire crimping parts 50A and 50A is provided to so as overlap with each other in crimping a wire 30 to prevent the damage on the wire 30. In the form depicted in FIG. 8, the wire crimping part 50A has a square shape, and is wound along the surface of the wire 30.

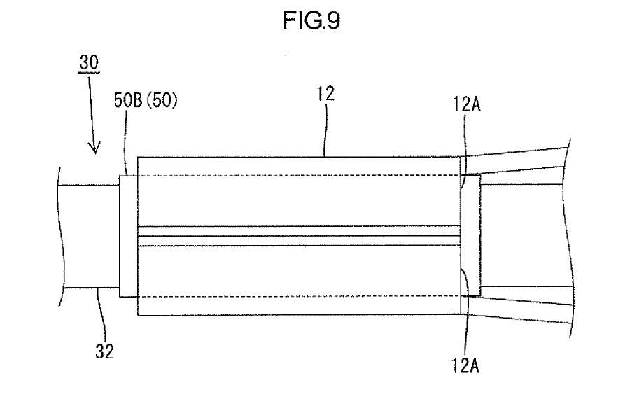

Moreover, as depicted in FIG. 9, a structure may be formed in which a resin or metal protective tube 50B is mounted on a wire 30, and then wire crimping parts 12A and 12A in the similar form as the wire crimping parts 12A according to the first embodiment are crimped and fixed over the protective tube. In the form depicted in FIG. 9, it is possible to prevent the damage on a wire regardless of the shape of wire crimping parts. For example, the shape of the crimping part may have the shapes depicted in FIGS. 7 and 8.

1. An overcurrent breaking element-equipped terminal comprising:
a terminal main body including:
a terminal portion connected to a power supply; and
a wire fixing portion configured to crimp and fix a wire electrically connecting the power supply to a load; and
an overcurrent breaking element configured to interrupt an electric current when an overcurrent is carried through the wire, or when a temperature of the wire reaches a set temperature or more, wherein:
the overcurrent breaking element includes a first lead wire connected to the terminal main body and a second lead wire connected to a terminal of the wire;
the terminal main body includes an element connecting part that crimps and connects the first lead wire; and
the element connecting part is crimped on the first lead wire, and a double crimp terminal is crimped to connect the terminal of the wire to the second lead wire to integrally provide the terminal main body, the overcurrent breaking element, and the wire.

2. The overcurrent breaking element-equipped terminal according to claim 1, wherein the terminal main body has a wall portion along a connecting portion region extending from a wire connecting portion where the terminal of the wire is connected to the second lead wire to an element connecting portion where the element connecting part is connected to the first lead wire.

3. The overcurrent breaking element-equipped terminal according to claim 2, wherein the wall portion has a reinforcing rib configured to reinforce the wall portion.

4. The overcurrent breaking element-equipped terminal according to claim 2, wherein the terminal portion is formed so as to extend from the wall portion.

5. The overcurrent breaking element-equipped terminal according to claim 1, wherein the wire fixing portion is a protection structure configured to prevent damage on the wire crimped and fixed to the wire fixing portion.

6. The overcurrent breaking element-equipped terminal according to claim 2, wherein the wire fixing portion is a protection structure configured to prevent damage on the wire crimped and fixed to the wire fixing portion.

7. The overcurrent breaking element-equipped terminal according to claim 3, wherein the wire fixing portion is a protection structure configured to prevent damage on the wire crimped and fixed to the wire fixing portion.

8. The overcurrent breaking element-equipped terminal according to claim 4, wherein the wire fixing portion is a protection structure configured to prevent damage on the wire crimped and fixed to the wire fixing portion.
